(19) United States
(12) Patent Application Publication
(10) Pub. No.: US 2010/0011924 A1
(43) Pub. Date: Jan. 21, 2010

(54) CORRUGATING APPARATUS

(75) Inventor: Georg BERNREUTER, Ursensollen (DE)

Correspondence Address: BROWDY AND NEIMARK, P.L.L.C.;624 NINTH STREET, NW, SUITE 300, WASHINGTON, DC, 20001-5303, US

(73) Assignee: BHS Corrugated Maschinen-und Anlagenbau GmbH, Weiherhammer (DE)

(21) Appl. No.: 12/195,297

(22) Filed: Aug. 20, 2008

(30) Foreign Application Priority Data
Jul. 18, 2008 (DE) 10 2008 033 776.5

(51) Int. Cl. B26D 1/00; B26D 7/06; B26D 1/24

(52) U.S. Cl. 83/39; 83/402; 83/495

(57) ABSTRACT

A device for cutting corrugated cardboard to defined sizes in a corrugating apparatus comprises at least one device for production of an at least single-faced corrugated web which is transported along a transport direction, at least one longitudinal-cutting device for creating cuts parallel to the transport direction in the corrugated web, at least one cross-cutting device for creating cuts perpendicular to the transport direction in the corrugated web and at least one diverter unit for controllably guiding the corrugated web along different, defined paths.

### BACKGROUND OF THE INVENTION

1. Field of the Invention

The invention concerns a corrugating apparatus. The invention further concerns a method of performing a size change in a corrugating apparatus.

2. Background Art

A corrugating apparatus produces endless webs of corrugated cardboard or corrugated webs, respectively, at transport speeds of for example 300 m/min. These corrugated webs are cut to the desired size by means of longitudinal cutters and cross cutters. From time to time, a size change is necessary. This produces scrap pieces which must be disposed of as waste material. Moreover, a size change may cause problems as to the stacking of the finished corrugated webs.

### SUMMARY OF THE INVENTION

Thus it is the object of the invention to improve a method of performing a size change in a corrugating apparatus. Another object of the invention is to provide a device for implementation of the improved method. This object is achieved by a corrugating apparatus comprising at least one device for production of an at least single-faced web of corrugated cardboard which is transported along a transport direction; at least one longitudinal-cutting device for creating cuts parallel to the transport direction in the web of corrugated cardboard; at least one cross-cutting device for creating cuts perpendicular to the transport direction in the web of corrugated cardboard; and at least one diverter unit for controllably guiding the web of corrugated cardboard along different, defined paths; and by a method of performing a size change when cutting a corrugated web, the method comprising the following steps:
providing a corrugating apparatus comprising at least one longitudinal-cutting device with a multitude of cutting elements which are displaceable perpendicular to a transport direction; and at least one cross-cutting device with at least one cross-cutting element for cutting the web of corrugated cardboard perpendicular to the transport direction;
engaging a first part of the cutting elements with the web of corrugated cardboard for longitudinally cutting the latter at a first, defined position perpendicular to the transport direction;
cutting the web of corrugated cardboard perpendicular to the transport direction by means of the at least one cross-cutting element;
disengaging the first part of the cutting elements from the web of corrugated cardboard; and
engaging a second part of the cutting elements with the web of corrugated cardboard for longitudinally cutting the latter at a second, defined position perpendicular to the transport direction.

The essence of the invention is to dispose at least one cross cutter and one longitudinal cutter in a corrugating apparatus.

Features and details of the invention will become apparent from the description of an embodiment by means of the drawings—

### BRIEF DESCRIPTION OF THE DRAWINGS

FIG. 1 shows a schematic side view of a partial area of a corrugating apparatus;

FIG. 2 shows a schematic side view of another part of a corrugating apparatus which is disposed downstream of the first part; and

FIG. 3 shows a schematic sectional view of a discharge device.

### DESCRIPTION OF THE PREFERRED EMBODIMENTS

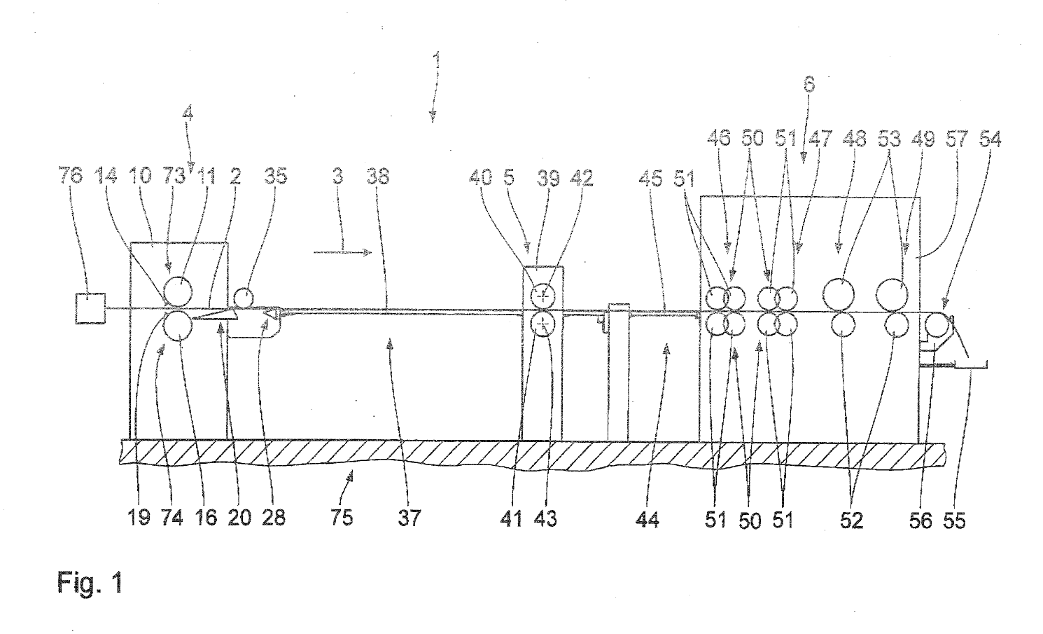

A corrugating apparatus 1 comprises a conventional prior-art corrugated-cardboard production machine 76 for producing an at least single-faced corrugated web 2, wherein the machine 76 is for example disclosed in DE 195 36 007 A to which reference is made for further details. The corrugated-cardboard production machine 76 is disposed on the left-hand side, in other words upstream relative to a transport direction 3, of the apparatus part according to FIG. 1 and is only shown in a schematic view.

Disposed in succession along the transport direction 3, the corrugating apparatus 1 comprises a cross-cutting discharge device 4, a first drive unit 5, a longitudinal-cutting grooving unit 6, a second drive unit 7, a diverter unit 8 for distributing the corrugated web 2 to different levels, a cross-cutting unit 9 and a stacking device which is disposed downstream thereof and is not shown in the Figures.

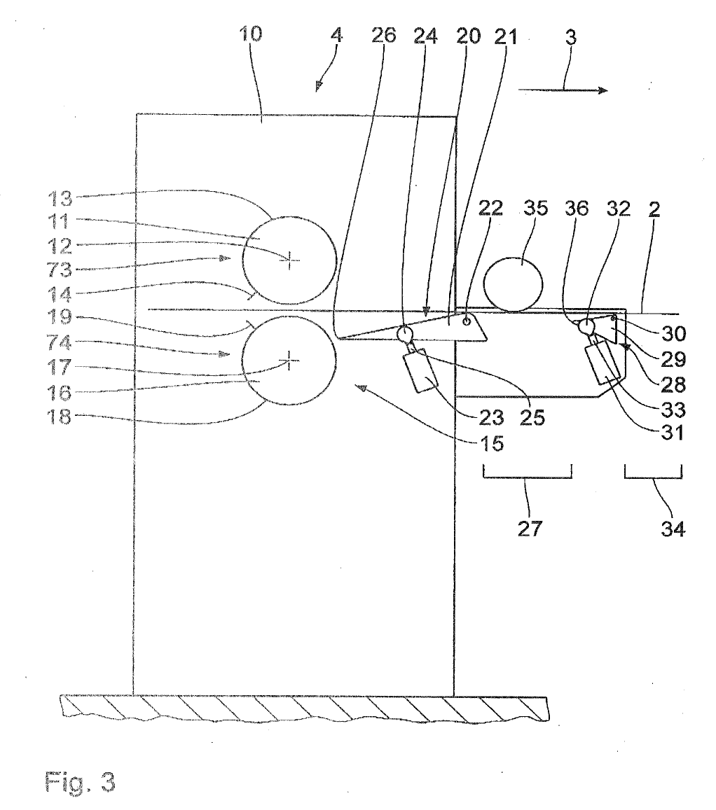

The following is a description of the cross-cutting discharge device 4 by means of FIG. 3. The cross-cutting discharge device 4 comprises a housing 10 in which a first roller 11 is mounted for rotary drive about an axis of rotation 12. The first roller 11 comprises a first lateral surface 13 to which a first knife 14 is fastened that extends radially outwards relative to the first axis of rotation 12 and across the entire width of the corrugated web 2. The first knife 14 is arranged helically about the first lateral surface 13 of the first roller 11 such that an inclination of the first axis of rotation 12 relative to the transport direction 3 is just compensated for in such a manner that the corrugated web 2 is cuttable just perpendicular to the transport direction 3 by means of the first knife 14. Advantageously, the first axis of rotation 12 is not exactly perpendicular to the transport direction 3, with the result that the corrugated web 2 is not cut along the entire width thereof in one stroke during the cross-cutting operation. Instead, the inclination of the first axis of rotation 12, combined with the helical arrangement of the first knife 14 which extends about the first lateral surface 13 of the first roller 11 such as to compensate for this inclination, enables the corrugated web 2 to be cut gradually during a revolution of the first roller 11 about the axis of rotation 12, wherein the cut produced in the corrugated web 2 is perpendicular to the transport direction 3. It is of course also conceivable to arrange the first axis of rotation 12 perpendicular to the transport direction 3. The first roller 11 comprising the first knife 14 forms a first cross-cutting element 73.

A counter element 15 of the first roller 11 is provided relative to the corrugated web 2 on the side opposite the first roller 11. According to the embodiment shown in FIG. 3, the counter element 15 is designed as a second roller 16 which is mirror-symmetric to the first roller 11 with respect to the corrugated web 2, wherein the second roller 16 is mounted for rotary drive about a second axis of rotation 17 and comprises a second lateral surface 18 with a second knife 19. Alternatively, it is conceivable for the counter element 15 to be designed as a brush roller. The second roller 16 comprising the second knife 19 forms a second cross-cutting element 74.

The second axis of rotation 17 of the second roller 16 is parallel to the first axis of rotation 12 of the first roller 11. Furthermore, the second knife 19 is arranged about the second lateral surface 18 of the second roller 16 such as to be exactly aligned with the first knife 14 which is arranged about the first lateral surface 13 of the first roller 11, with the result that the knives 14, 19 abut against each other along their entire length during a revolution of the rollers 11, 16.

The cross-cutting discharge device 4 further comprises a first paddle unit 20. The first paddle unit 20 is disposed downstream of the rollers 11, 16 along the transport direction 3. The first paddle unit 20 comprises a first wedge-shaped paddle 21 which is mounted for pivoting movement about a first paddle axis 22. The first paddle axis 22 is perpendicular to the transport direction 3. The first paddle axis is disposed slightly below the corrugated web 2. The first paddle 21 is pivoted about the first paddle axis 22 by way of a first hydraulic cylinder 23 comprising a first piston rod 25 which is articulated to the first paddle 22 by means of a first joint 24. The first hydraulic cylinder 23 is activatable by means of a control device not shown in the Figures. The first paddle 21 is wedge-shaped and tapers at a small angle, and comprises a first paddle edge 26 facing the rollers 11, 16.

Assigned to the first paddle unit 20, a first collection unit 27 is provided slightly downstream of and below said first paddle unit 20. The first collection unit 27 is for example designed as a collection basket.

Corresponding to the first paddle unit 20, a second paddle unit 28 comprising a second paddle 29 with a second paddle edge 36 is provided downstream of said first paddle unit 20, wherein the second paddle 29 is mounted for pivoting movement about a second paddle axis 30, the second paddle unit 28 further comprising a second hydraulic cylinder 31 with a second piston rod 33, which is connected to the second paddle 29 by means of a second joint 32, and a second collection unit 34 assigned to said paddle unit 28.

The paddles 21, 29 are arranged relative to the corrugated web 2 such that their respective paddle edges 26, 36 are engageable with the corrugated web 2. The paddle units 20, 28 are activatable and controllable independently from one another. The paddles 21, 29 are pivotable from their lower into their upper position within less than 1 sec, in particular less than 0.5 sec, in particular less than 0.1 sec. They are therefore also referred to as quick flaps.

The paddles 21, 29 extend across the entire width of the corrugated web 2. In an alternative embodiment, it is provided that perpendicular to the transport direction 3, the paddles are divided into several segments which are pivotable independently from one another by means of hydraulic units. This further enhances the flexibility of the cross-cutting discharge device 4.

Furthermore, the cross-cutting discharge device 4 comprises a drive roller 35 which is drivable for rotation.

The housing 10 of the cross-cutting discharge device 4 is designed such that the corrugated web 2 is guidable through the housing 10 between the rollers 11, 16.

Downstream of the cross-cutting discharge device 4 is disposed a first support table 37 comprising a low-friction first support surface 38.

The first drive unit 5 comprises a housing 39 in which two drive rollers 40, 41 are in each case mounted for rotary drive about axes of rotation 42, 43 which extend perpendicular to the transport direction 3. The axes of rotation 42, 43 are parallel to each other. They are spaced from one another such that the corrugated web 2 is just able to pass through between the drive rollers 40, 41. The distance between the axes of rotation 42, 43 is advantageously adjustable by means of an adjustment system provided in the housing 39. In another, particularly advantageous embodiment, at least one, in particular both drive rollers 40, 41 are resiliently mounted such that they exert a contact pressure on the corrugated web 2 guided between them.

Downstream of the first drive unit 5 is provided a second support table 44 with a second support surface 45.

The longitudinal-cutting grooving unit 6 comprises a first grooving unit 46, a second grooving unit 47, a first longitudinal-cutting unit 48 and a second longitudinal-cutting unit 49. Each of the grooving units 46, 47 comprises two tool beds 50 which are disposed one above the other and mirror-symmetrically with respect to the corrugated web 2. The pivotable tool beds 50 are provided with grooving tools 51 which are disposed on tool carriers and are individually displaceable perpendicular to the transport direction 3. In the transport direction 3, two grooving tools 51 each are arranged in pairs on a common tool carrier.

Likewise, the longitudinal-cutting units 48, 49 also comprise tool beds which are provided with individually displaceable rotating knives 52 that are disposed on tool carriers. The knives 52 are individually engageable with the corrugated web 2 and cooperate with brush rollers 53 which are disposed on the opposite side of the corrugated web 2 and are drivable for rotation. The rotating knives 52 are advantageously disposed below the corrugated web 2 so as to ensure that the corrugated web 2 is pressed against the rotating knives 52 due to its own weight as well. It is however also conceivable to arrange the rotating knives 52 above the corrugated web 2.

For a detailed description of the general design of the longitudinal-cutting grooving unit 6, reference is made to DE 197 54 799 A and to DE 101 31 833 A.

The longitudinal-cutting grooving unit 6 is connected to a control unit (not shown in the Figures) for signal transmission. The control unit is further connected to the cross-cutting discharge device 4 so as to ensure a coordinated activation of the longitudinal-cutting grooving unit 6 and the cross-cutting discharge device 4.

On the upstream end, the longitudinal-cutting grooving unit 6 has two edge-cutting elements 54 with respectively assigned collection elements 55. Likewise, each of the edge-cutting elements 54 has one rotating knife 52. The rotating knives 52 of the edge-cutting elements 54 are in each case mounted for rotation on a retaining element 56. The retaining element 56 may be a height-adjustable arm disposed at a housing 57 of the longitudinal-cutting grooving unit 6. The retaining element 56 may however also be disposed at the housing in a pivotable manner. What is essential is that each of the rotating knives 52 of the edge-cutting elements 54 is engageable with the corrugated web 2 or retractable therefrom, respectively.

Moreover, the rotating knives 52 of the edge-cutting element 54 are individually displaceable perpendicular to the transport direction 3. It is particularly advantageous if the rotating knives 52 of the edge-cutting element 54 are orientable relative to the transport direction 3. An arrangement of this type is also referred to as a swinging arrangement. Not shown in the Figures, two additional edge-cutting elements 54 may be provided to ensure enhanced flexibility in the event of a size change.

The collection element 55 is a collection basket or a collection bag which advantageously comprises an exhaust device not shown in the Figures.

The design of second drive unit 7 corresponds to that of the first drive unit 5 to the description of which reference is made. The drive units 5, 7 enable a tensile force to be applied to the corrugated web 2 disposed downstream thereof.

The diverter unit 8 comprises a support element 58 which is segmented in a direction perpendicular to the transport direction 3. Designed in a comb-like manner, the support element 58 comprises a multitude of longitudinal finger-shaped prongs 59 which are in each case pivotable independently from one another about a diverter axis 60 which is perpendicular to the transport direction 3. Each of the prongs 59 has a flexible projection 61 at the free end thereof.

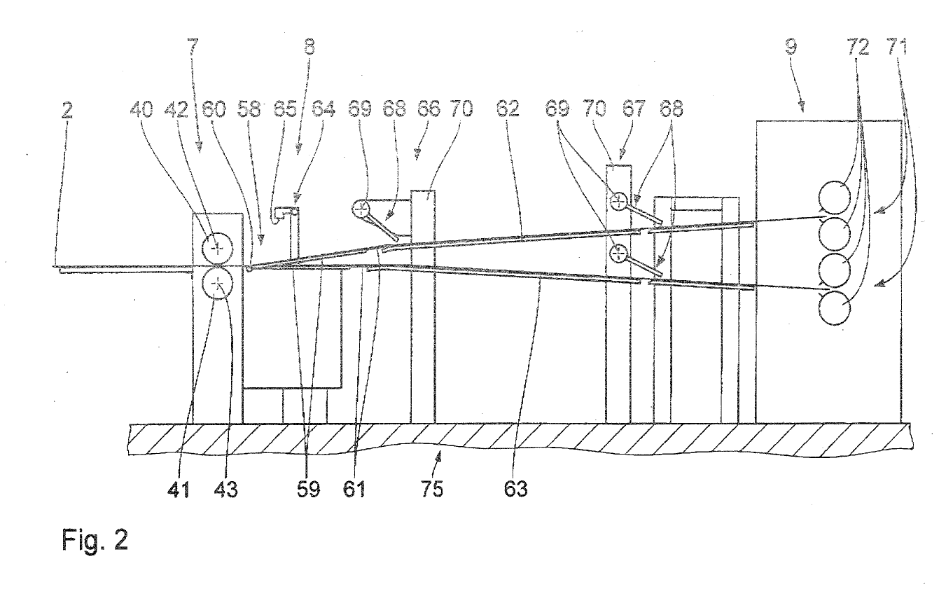

The prongs 59 are pivotable between a lower and an upper position, both indicated in FIG. 2, independently from one another by means of a drive not shown in the Figures. In the upper position, the prongs 59 are in line with an upper diverter table 62 disposed downstream in the transport direction 3, wherein the elastic projections 61 ensure a particularly smooth transition. When in the lower position, the prongs 59 are correspondingly in line with a lower diverter table 63.

The diverter tables 62, 63 extend across the entire width of the corrugated web 2. The diverter tables 62, 63 may be composed of several parts in the transport direction 3. Moreover, the diverter tables 62, 63 are assigned to guide units 66, 67 which ensure a safe positioning of the corrugated web 2 on the diverter tables 62, 63. Each of the guide units 66, 67 comprises at least one holding-down element 68. The holding-down element 68 is in the shape of a rake which is in particular fabricated from fiberglass and/or plastics material or another flexible material. The holding-down element 68 is in each case disposed above one of the diverter tables 62, 63. It is in each case mounted on a stand 70 for pivoting movement about a pivot axis 69. Along the transport direction 3, the holding-down element 68 is in each case preferably disposed in the vicinity of the upstream end of a part of the diverter tables 62, 63.

The diverter unit 8 further comprises a blower device 64 which is subjectable to compressed air. The blower device 64 comprises a multitude of nozzles 65, wherein exactly one nozzle 65 is assigned to a respective prong 59 of the support element 58. The nozzle 65 assigned to the respective prong 59 is in each case disposed vertically above the prong 59. The nozzles 65 are disposed in the vicinity of the free ends of the prongs 59 facing the diverter tables 62, 63. Each nozzle 65 is subjectable to compressed air independently from the others. To this end, a central control unit is provided which is not shown in the Figures. With respect to further details of the diverter unit 8, in particular of the blower device 64, reference shall be made to DE 103 54 671 A1.

The cross-cutting unit 9 comprises two cross-cutters 71 which are disposed one above the other. To this end, one of the cross-cutters 71 is arranged at the level of the upper diverter table 62 while the other is arranged at the level of the lower diverter table 63. Each cross-cutter 71 comprises two cross-cutting rollers 72 which are drivable for rotation and are disposed one above the other. With respect to the design and the arrangement of the cross-cutting rollers 72, reference shall be made to the description of the cross-cutting elements 73, 74 in the cross-cutting discharge device 4.

The following is a description of the operation of the corrugating apparatus 1. Produced by the corrugated-cardboard production machine 76 in a known manner, the corrugated web 2 is guided through the cross-cutting discharge device 4 between the first roller 11 and the second roller 16 along the transport direction 3. In the initial state, the knives 14, 19 are not in engagement with the corrugated web 2. The paddles 21, 29 of the paddle units 20, 28 are in their lower position and are therefore not in engagement with the corrugated web 2 either. When the cross-cutting discharge device 4 is in its rest or initial state, the corrugated web 2 thus passes through the cross-cutting discharge device 4 without interference. The corrugated web 2 is in particular free of engagement when it is pulled through the cross-cutting discharge device 4 along the transport direction 3 by way of the drive roller 35 and the drive rollers 40, 41 of the first drive unit 5, with the drive rollers 40, 41 being driven at a constant torque.

From time to time it may occur that individual sections of the corrugated web 2 are not suitable for further processing and therefore need to be discharged. This is the case for example in the event of a size change or a production error which can never be completely ruled out. In order to discharge a section of the corrugated web 2, one of the paddle units 20, 28 is activated. When this happens, the paddle 21, 29 of the respectively activated paddle unit 20, 28 is pivoted, by activation of the respectively assigned hydraulic cylinder 23, 31, about its paddle axis 20, 30 such that the paddle edge 26, 36 comes to rest above the corrugated web 2 in its initial position. The paddle 21, 29 thus engages with the corrugated web 2 so as to deflect the corrugated web 2 downwards into the respectively assigned collection unit 27, 34. The first paddle unit 20 in particular serves to discharge loose paper and corrugated cardboard with a low bending stiffness. The second paddle unit 28 in particular serves to discharge waste cardboard with a higher bending stiffness, for instance in the event of a size change.

The rollers 11, 16 comprising the knives 14, 19 enable a clean cut to be made when cutting through the corrugated web 2 perpendicular to the transport direction 3. The activation of the paddle units 20, 28 is in particular linked with the control of the rollers 11, 16 for cross-cutting the corrugated web 2 such that only a minimum amount of space is required in order to discharge pieces of waste cardboard perpendicular to the transport direction 3.

When cutting corrugated webs in the normal mode, in other words with no size change involved, one of the longitudinal-cutting units 48, 49 is in engagement with the corrugated web 2 while the respective other longitudinal-cutting unit 48, 49 has been retracted from the corrugated web 2 and is therefore not in engagement therewith. The number of rotating knives 52 of the respective longitudinal-cutting unit 48, 49, which are in engagement with the corrugated web 2, depends on the respective task, in other words on how the corrugated web 2 needs to be cut.

When the rotating knives 52 of one of the longitudinal-cutting units 48, 49 engage with the corrugated web 2, the corrugated web 2 is provided with continuous longitudinal cuts, in other words it is divided into several endless webs of a defined width, wherein the arrangement of the knives 52 of the longitudinal-cutting units 48, 49 in a direction perpendicular to the transport direction 3 is freely selectable and adjustable by way of the control device. Each of the two edge-cutting elements 54 cuts off a respective outer edge strip which is then discharged into the respectively assigned collection element 55.

Corresponding to the longitudinal cuts produced by means of one of the longitudinal-cutting units 48, 49, the corrugated web 2 can optionally be provided with longitudinal grooves by means of one of the two grooving units 46, 47. The respective other of the two grooving units 46, 47 is then not in engagement with the corrugated web 2.

In the diverter unit 8, the thus produced partial webs of the corrugated web 2 are optionally guided to the upper and lower diverter table 62, 63. Distribution of the partial webs of the corrugated web 2 is facilitated by using compressed air provided by the blower device 64. To this end, the blower device 64 is advantageously operated periodically, which means that the respectively required nozzles 65 are only subject to compressed air for a short interval of less than 1 sec, in particular less than 0.5 sec.

Cutting the partial webs of the corrugated web 2 into pieces of a defined length is performed by controlled activation of the two cross-cutters 71 of the cross-cutting unit 9.

The following is a description of a size change. For the description of the size change, it shall be assumed that prior to the size change, the rotating knives 52 of the first longitudinal-cutting unit 48, and optionally the grooving tools 51 of the first grooving unit 46, are in engagement with the corrugated web 2 while the rotating knives 52 of the second longitudinal-cutting unit 49 and the grooving tools 51 of the second grooving unit 47 are not in engagement with the corrugated web 2. The size change is provided for by defining the desired positions of the rotating knives 52 of the second longitudinal-cutting unit 49, and optionally those of the grooving tools 51 of the second grooving unit 47, before moving the knives 52 or the grooving tools 51, respectively, to the corresponding lateral position. Likewise, the width of the edge strips is optionally also changed in a corresponding manner. To this end, two additional edge-cutting elements 54 may be provided which are not shown in the Figures. The actual size change starts by activating the cutting elements 73, 74 of the cross-cutting discharge device 4 for cutting the corrugated web 2. Since after cutting the corrugated web 2, the tensile force applied to the corrugated web 2 by way of the drive units 5, 7 is no longer compensated for by a corresponding counter force of the upstream corrugated web 2 and, furthermore, the downstream free end of the corrugated web 2 in the cross-cutting discharge device 4 is not subject to a tensile force by way of the drive units 5, 7, the upstream-facing free end of the corrugated web 2, which is cut to the old size, moves ahead of the downstream-facing free end of the corrugated web 2, which is to be cut to the new size. While the corrugated web 2 is usually moved along the transport direction 3 at a speed in the range of 200 to 300 m/min, the speed of the upstream-facing free end of the corrugated web 2 is increased by up to 20%, i.e. by up to 60 m/min when the cutting operation in the cross-cutting discharge device 4 is finished.

As soon as the upstream-facing free end of the corrugated web 2, which has been cut to the old size, has passed over the rotating knife 52 of the first longitudinal-cutting unit 48 of the longitudinal-cutting grooving unit 6 in the transport direction 3, the first longitudinal-cutting unit 48 is displaced to a position in which the rotating knife 52 thereof is not able to engage with the corrugated web 2. Corresponding thereto, when the free end of the corrugated web 2 has passed over the rotating knife 52 of the second longitudinal-cutting unit 49, said rotating knife 52 is displaced to a position in which it engages with the corrugated web 2 which is to be cut to the new size.

Displacement of the longitudinal-cutting units 48, 49 is controlled by the control device. The exact point of disengagement or engagement, respectively, of the longitudinal-cutting units 48, 49 with the corrugated web 2 is definable by way of sensors. Alternatively, it is provided that the point of disengagement or engagement, respectively, of the longitudinal-cutting units 48, 49 with the corrugated web 2 is linked, by way of the control device, with the point of activation of the cross-cutting elements 73, 74 of the cross-cutting discharge device 4.

Since according to the above description, the upstream-facing free end moves ahead of the downstream-facing free end, a gap is created between these ends in the transport direction 3, the gap having a length of up to 1 m. Retraction of the first longitudinal-cutting unit 48 and extension of the second longitudinal-cutting unit 49 advantageously take place at the instant when said gap passes through the respective cross-cutting unit 48, 49. The time required to completely extend or retract the longitudinal-cutting unit 48, 49 amounts to less than 1 sec, in particular less than 0.5 sec, in particular less than 0.2 sec.

The grooving units 46, 47 are optionally activated and displaced in accordance with the longitudinal-cutting units 48, 49.

A size change may of course also be performed in a corresponding manner by retracting the second longitudinal-cutting unit 49 and engaging the first longitudinal-cutting unit 48, wherein the first longitudinal-cutting unit 48 may already be displaced to its engagement position while the second longitudinal-cutting unit 49 is still cutting the last end of the corrugated web 2.

The inventive corrugating apparatus 1 thus enables a waste-free size change to be performed.

What is claimed is:

1. A corrugating apparatus comprising
a. at least one device (76) for production of an at least single-faced web (2) of corrugated cardboard which is transported along a transport direction (3);
b. at least one longitudinal-cutting device (6) for creating cuts parallel to the transport direction (3) in the web (2) of corrugated cardboard;
c. at least one cross-cutting device (4, 9) for creating cuts perpendicular to the transport direction (3) in the web (2) of corrugated cardboard;
d. at least one diverter unit (8) for controllably guiding the web (2) of corrugated cardboard along different, defined paths.

2. A corrugating apparatus according to claim 1, wherein the longitudinal-cutting device (6) comprises at least two longitudinal-cutting units (48, 49).

3. A corrugating apparatus according to claim 2, wherein the longitudinal cutting units (48, 49) in each case comprise several rotating knives (52).

4. A corrugating apparatus according to claim 3, wherein the rotating knives (52) are displaceable perpendicular to the transport direction (3) independently from one another.

5. A corrugating apparatus according to claim 2, wherein the longitudinal-cutting units (48, 49) are engageable with the web (2) of corrugated cardboard independently from one another.

6. A corrugating apparatus according to claim 1, wherein the diverter unit (8) comprises a compressed-air operated blower device (64).

7. A corrugating apparatus according to claim 6, wherein the blower device (64) is operable periodically.

8. A corrugating apparatus according to claim 1, wherein at least one of the cross-cutting devices (4, 9) is disposed opposite to the transport direction (3) relative to the at least one longitudinal-cutting device (6).

9. A corrugating apparatus according to claim 8, wherein the web (2) of corrugated cardboard is cuttable across its entire width by means of the cross-cutting device (4, 9).

10. A method of performing a size change when cutting a corrugated web (2), the method comprising the following steps:
providing a corrugating apparatus (1) comprising
at least one longitudinal-cutting device (6) with a multitude of cutting elements (52) which are displaceable perpendicular to a transport direction (3); and
at least one cross-cutting device (4) with at least one cross-cutting element (73, 74) for cutting the web (2) of corrugated cardboard perpendicular to the transport direction (3);
engaging a first part of the cutting elements (52) with the web (2) of corrugated cardboard for longitudinally cutting the latter at a first, defined position perpendicular to the transport direction (3);
cutting the web (2) of corrugated cardboard perpendicular to the transport direction (3) by means of the at least one cross-cutting element (73, 74);
disengaging the first part of the cutting elements (52) from the web (2) of corrugated cardboard; and
engaging a second part of the cutting elements (52) with the web (2) of corrugated cardboard for longitudinally cutting the latter at a second, defined position perpendicular to the transport direction (3).
